(19) United States
(12) Patent Application Publication
(10) Pub. No.: US 2007/0022168 A1
(43) Pub. Date: Jan. 25, 2007

(54) Communication terminal and customize method

(75) Inventor: Akio Suzuki, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/386,968

(22) Filed: Mar. 22, 2006

(30) Foreign Application Priority Data
Jul. 19, 2005 (JP) 2005-208921

(51) Int. Cl. G06F 15/16

(52) U.S. Cl. 709/206

(57) ABSTRACT

A communication terminal includes a mail processing unit executing e-mail processing, a status determining unit determining an execution status of the e-mail processing, and a customizing executing unit executing customizing with respect to the e-mail processing in accordance with the execution status determined by the status determining unit.

### CROSS-REFERENCE TO RELATED APPLICATIONS

This application is based upon and claims the benefit of priority from prior Japanese Patent Application No. 2005-208921, filed Jul. 19, 2005, the entire contents of which are incorporated herein by reference.

### BACKGROUND OF THE INVENTION

1. Field of the Invention

The present invention relates to communication terminals such as fixed telephone, mobile phone and personal digital assistants (PDAs). In particular, the present invention relates to a communication terminal having a function of transmitting and receiving an electronic mail (referred to as e-mail, hereinafter).

2. Description of the Related Art

In general, a typical communication terminal, that is, a mobile phone is provided with a function of transmitting and receiving an e-mail, and the frequency of utilizing the function becomes very high. Therefore, it is desired to improve an operability of a function for handling the e-mail.

Conventionally, various customizing (optimization) are possible to improve the operability. For example, shortcut is registered, and functions having low available frequency are deleted from a menu. The shortcut simply provides quick access to a function having high available frequency to enhance the operational availability. In the conventional communication terminal, the user must manually set the foregoing customizing individually. For example, when registering the shortcut, the user starts a function of registering shortcuts, and then, selects a function to be added. Thereafter, the user must register a shortcut icon corresponding to the selected function on a predetermined screen. Moreover, when deleting menus, the user starts a menu delete function, and then, selects an unnecessary menu from the menus, and thereafter, must make instructions to delete the menu.

However, the user requiring the operation customizing the most, that is, the user unaccustomed to the operation of the communication terminal, cannot customize because the customize operation is completed.

Conventionally, an e-mail message system for readily sorting and managing e-mails has been proposed (e.g., see PCT National Publication No. 2004-519047). The e-mail message system provides e-mail address including suffix, user and domain names to the third party. The system creates a directory corresponding to the suffix name with respect to the e-mail address including suffix name transmitted by the third party, and then, stores the e-mail message.

As described above, the user must manually customize in the conventional communication terminal. For this reason, the user unaccustomed to the operation of the communication terminal is hard to improve the operability via customize.

Moreover, the e-mail message system disclosed in the foregoing Publication can sort the received e-mail every suffix name. In order to achieve this, the user previously generates the suffix name to provide it to the third party. However, there exists a user, who is unaccustomed to making the operation of generating the suffix name to provide it the third party. Such a user cannot sort the foregoing e-mail. In addition, the system sorts and stores only e-mails from the third party providing the suffix name.

### BRIEF SUMMARY OF THE INVENTION

An object of the present invention is to provide a communication terminal, which can reduce an operation load required for customizing a function of handing an e-mail, and can provide the optimum operability to the user.

According to an embodiment of the present invention, there is provided a communication terminal comprising:

a mail processing unit configured to execute e-mail processing;

a status determining unit configured to determine an execution status of the e-mail processing; and

a customizing executing unit configured to execute customizing with respect to the e-mail processing in accordance with the execution status determined by the status determining unit.

### BRIEF DESCRIPTION OF THE SEVERAL VIEWS OF THE DRAWING

FIG. 1 is a view showing the circuit configuration of a mobile phone according to an embodiment of the present invention;

FIG. 2 is a flowchart to explain the customizing setup procedure in the mobile phone of the embodiment;

FIGS. 3A, 3B and 3C are views showing a customizing setup screen in the embodiment;

FIG. 4 is a flowchart to explain the mail sending/receiving procedure in the embodiment;

FIGS. 5A, 5B and 5C are views showing a transmitter (sender) mail address and folder addition;

FIGS. 6A and 6B are addition receiving function table and addition sending function table in the embodiment, respectively;

FIG. 7 is a flowchart to explain the e-mail sending procedure in the embodiment;

FIG. 8 is a flowchart to explain the e-mail receiving procedure in the embodiment;

FIGS. 9A and 9B are views showing an example of adding a function (selection item) to menus of the embodiment;

FIGS. 10A, 10B and 10C are views showing an example of adding function (selection item) to menus of the embodiment;

FIG. 11 is a flowchart to explain the function delete procedure in the embodiment; and

FIGS. 12A, 12B and 12C are views showing an example of deleting a function (selection item) from menus of the embodiment.

### DETAILED DESCRIPTION OF THE INVENTION

An embodiment of the present invention will be described below with reference to the accompanying drawings.

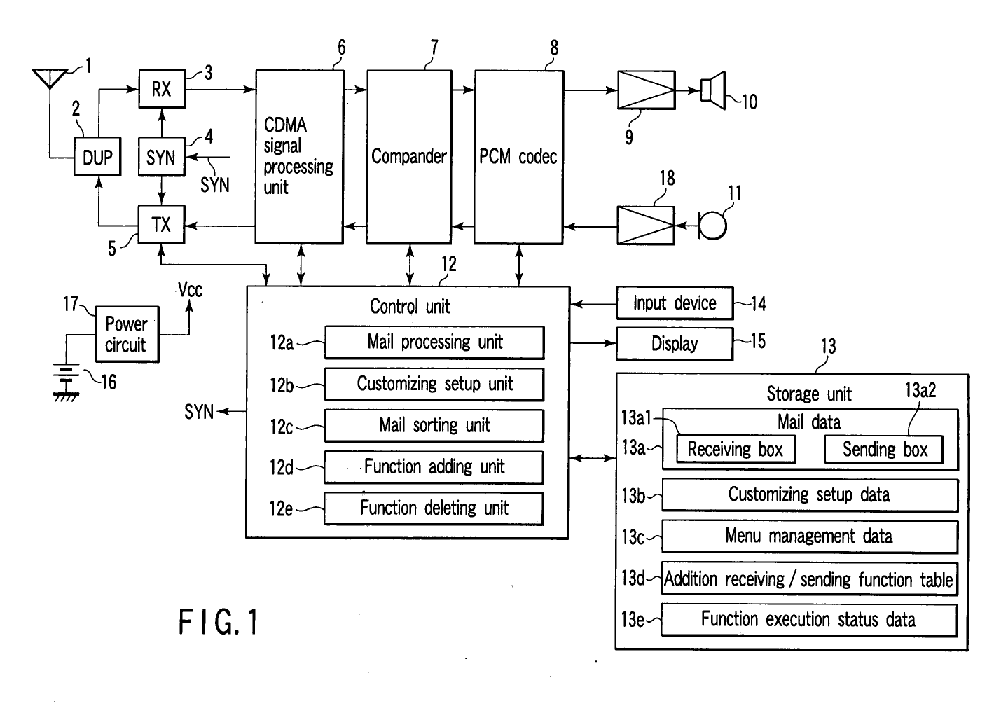

FIG. 1 is a view showing the circuit configuration of a mobile phone according to an embodiment.

In FIG. 1, a radio signal transmitted from a base station (not shown) is received by an antenna 1, and thereafter, input to a receiver circuit (RX) 3 via an antenna duplexer (DUP) 2. The receiver circuit 3 mixes the received radio signal with a local oscillation signal output from a frequency synthesizer (SYN) 4 to down-convert it into an intermediate frequency signal. Then, the receiver circuit 3 orthogonally demodulates the down-converted intermediate frequency signal to output a receiving baseband signal. In this case, the local oscillation signal frequency generated from the frequency synthesizer 4 is set according to a control signal SYC output from a control unit 12.

The receiving base band signal is input to a code division multiple access (CDMA) signal processing unit 6. The CDMA signal processing unit 6 includes a RAKE receiver. The RAKE receiver back-spreads several paths contained in the receiving baseband signal using spread codes. The signals having back-diffused paths are arbitrated, and thereafter, synthesized. In this manner, receiving packet data having a predetermined transmission format is obtained. The receiving packet data is input to a compression/decompression processing unit (referred to as compander, hereinafter) 7.

The compander 7 separates the receiving packet data output from the CDMA signal processing unit 6 every media using a multiplex separation unit. Then, the compander 7 decodes the data separated every media. For example, if the receiving packet data contains audio data, a speech codec decodes the audio data. Moreover, if the receiving packet data contains video data, a video codec decodes the video data.

A digital audio signal obtained according to decoding is supplied to a PCM coding unit 8 (referred to as PCM codec, hereinafter). The PCM codec 8 PCM-decodes the digital audio signal output from the compander 7 to output an analog audio signal. The analog audio signal is amplified by a receive amplifier 9, and thereafter, output from a speaker 10.

The digital video signal decoded by the video codec of the compander 7 is input to a control unit 12. The control unit 12 displays the digital video signal output from the compander 7 on a display 15 via a video RAM. The display 15 comprises a liquid crystal display (LCD). Incidentally, the control unit 12 displays video data captured (picked-up) by a camera (not shown) via the video RAM in addition to the received video data.

If the receiving packet data is e-mail, the compander 7 outputs the e-mail to the control unit 12. The control unit 12 stores the e-mail in a storage unit 13 (receiving box 13a1 of mail data 13a). An input device 14 reads e-mail from the receiving box 13a1 to display it on the display 15 in accordance with a display operation by the user. On the display 15, much information is displayed. Specifically, information to show a device operation mode, information to notify a call, information to show the residual level of a battery 16 and charge state, and clock to show the present time are given.

On the other hand, a voice signal of a talker input to a microphone 11 is amplified to a proper level by a speech amplifier 18. Thereafter, the voice signal is subjected to PCM coding by the PCM codec 8, and then, input to the compander 7 after being converted into a digital audio signal. Moreover, a video signal output from the camera (not shown) is digitized via the control unit 12, and thereafter, input to the compander 7. An e-mail created in the control unit is input from the control unit 12 to the compander 7.

The compander 7 detects input voice energy from the digital audio signal output from the PCM codec 8, and based on the detection result, determines a transmission date rate. The compander 7 codes the digital audio signal into a signal having a format corresponding to the transmission data rate, thereby generating audio data. Moreover, the compander 7 codes the digital video signal output from the control unit 12 to generate video data. The compander 7 multiplexes the foregoing audio and video data according to a predetermined transmission format using a multiplex separation unit to generate transmission packet data. Then, the compander 7 outputs the transmission packet data to the CDMA signal processing unit 6. Incidentally, if an e-mail is output from the control unit 12, the compander 7 converts the e-mail into packet data.

The CDMA signal processing unit 6 carries out spectrum spread processing with respect to the transmission packet data output from the compander 7 using spread codes allocated to transmission channels. Thereafter, the CDMA signal processing unit 6 outputs the output signal to the transmitter circuit 5. The transmitter circuit 5 modulates the spectrum-spread signal using digital modulation such as quadrature phase-shift keying (QPSK). The transmitter circuit 5 further synthesizes a transmission signal generated by the modulation and the local oscillation signal generated from the frequency synthesizer 4, and then, converts it into a radio signal frequency. The transmitter circuit 5 amplifies the radio signal to high frequency so that the radio signal becomes a transmission power level instructed by the control unit 12. The radio signal thus amplified is supplied to the antenna 11 via the antenna duplexer 2, and thereafter, transmitted to a base station from the antenna 11.

The input device 14 is provided with dial keys (character keys) and several function keys. The function keys include transmission key, end key, power key, volume control key, mode designation key and cursor key. The power circuit 17 generates a predetermined operating power supply voltage Vcc using the output of a battery 16 as a source, and then, supplies it to various circuits. In this case, the battery 16 is chargeable via a charger circuit (not shown).

The control unit 12 includes a microcomputer, for example. The control unit 12 is provided with the following various units as a control function according to the present invention. Specifically, a mail processing unit 12a, customizing setup unit 12b, mail sorting unit 12c, function adding unit 12d and function deleting unit 12e are given. These units 12a to 12e are realized by executing programs on the microcomputer.

The mail processing unit 12a executes various processing relevant to e-mail. For example, the mail processing unit 12a executes the following processing. One is e-mail sending/receiving processing of transmitting and receiving e-mails. Another is processing of displaying transmitted and received e-mails. Another is processing of creating (edit) e-mail, and still another is setup processing including customizing various functions relevant to e-mail. The mail processing unit 12a manages mail address showing sending destination of e-mail and an address book storing various data including name information relevant to the sending destination. Moreover, the mail processing unit 12a manages an execution status of various processing relevant to e-mail. As the execution status, counts of transmitting and receiving e-mail, processing execution time and execution frequency are given.

The customizing setup unit 12b executes customizing setup for setting whether or not customizing with respect to various processing relevant to e-mail should be executed.

The mail sorting unit 12c, function adding unit 12d and function deleting unit 12e executes customizing with respect to processing of handling e-mail.

When the mail processing unit 12a transmits and receives e-mail, the mail sorting unit 12c determines whether or not storage location corresponding to the mail address of the e-mail is set in the storage unit 13 (receiving box 13a1, sending box 13a2). If the storage location is not set therein, the mail sorting unit 12c sets a storage location in accordance with the mail address. Then, data of sent and received e-mails is stored in the storage location thus set, and thereby, the unit 12c automatically sorts sent and received e-mails.

The function adding unit 12d automatically adds selection, for example, items and icons to a menu for instructing to execute various processing to e-mail in accordance with an e-mail processing execution status by the mail processing unit 12a. The function adding unit 12d stores execution status adding the selection in an addition receiving/sending function table 13d (described later) every selection added to the menu. If the execution status stored in the table is given, the function adding unit 12d adds the selection corresponding to the execution status to the menu.

The function deleting unit 12e deletes selection from the menu for instructing to execute various processing to e-mail in accordance with the e-mail processing execution status.

The mobile phone of this embodiment includes a storage unit 13. The storage unit 13 uses an electrically erasable and programmable ROM (EEPROM) or hard disk as a storage medium. For example, the storage unit 13 is stored with mail data 13a, customizing setup data 13b, menu management data 13c, addition receiving/sending function table 13d, and function execution status data 13e.

The mail data 13a includes sent and received e-mail and its sending and receiving history data. A received e-mail is stored in a receiving box 13a1; on the other hand, a sent e-mail is stored in a sending box 13a2. In this embodiment, the mail sorting unit 12c generates a storage location (folder) every e-mail sender (every e-mail address) in the receiving box 13a1. The unit 12c sorts the e-mail into each folder to store mail data. Likewise, the mail sorting unit 12c generates a storage location (folder) every e-mail sending destination (every e-mail address) in the sending box 13a2. The unit 12c sorts the e-mail into each folder to store mail data.

The customizing setup data 13b is data set by the customizing setup unit 12b, and shows whether or not customizing to e-mail processing should be executed.

The menu management data 13c is data managing a menu for instructing to execute e-mail processing. The menu management data 13c includes selections (items, icons) corresponding to various processings set in the menu. If “function adding/deleting” is customized, the menu management data 13c is automatically updated by the function adding unit 12d or the function deleting unit 12e.

The addition receiving/sending function table 13d is stored with an execution status on which the function adding unit 12d adds selection to the menu every selection. The table 13d includes addition receiving function table and addition sending function table (see FIG. 6A and FIG. 6B). The addition receiving function table stores an execution status of selection for executing e-mail receiving processing. The addition receiving function table stores an execution status of selection for executing e-mail sending processing.

The function execution status data 13e is data showing an execution status of e-mal processing by the mail processing unit 12a. For example, the data 13e includes e-mail total sending count updated by e-mail sending processing described later, e-mail total receiving count updated by e-mail receiving processing, execution frequency every processing, or processing execution time. In this case, the foregoing total sending count and total receiving count are stored in a state that the initial value is set to zero.

The operation o the mobile phone having the configuration will be explained below.

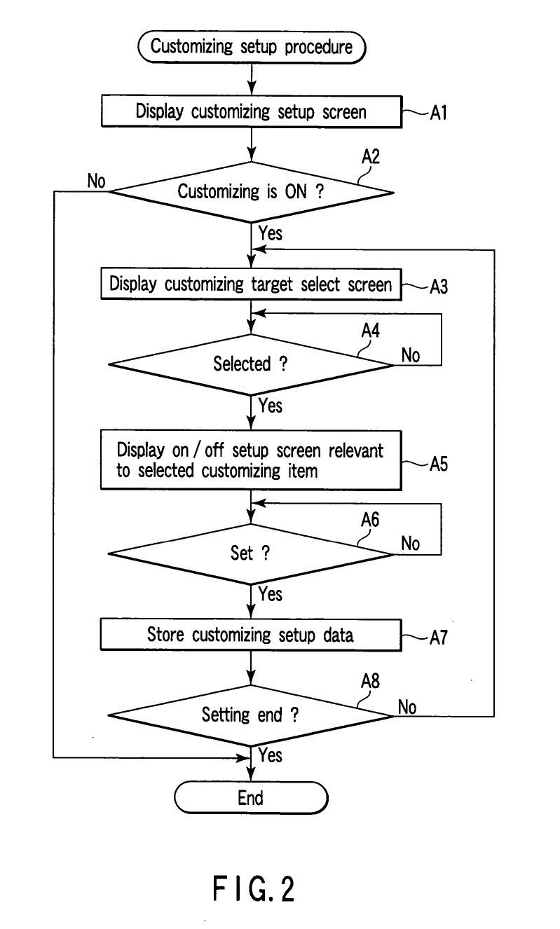

First, a customizing setup procedure of the mobile phone will be explained below with reference to a flowchart shown in FIG. 2. The customizing setup procedure is taken to achieve the setting given below. Specifically, the user can optionally set whether or not auto-customizing is made in accordance with the execution status (time, frequency, sending/receiving count) of the mobile phone.

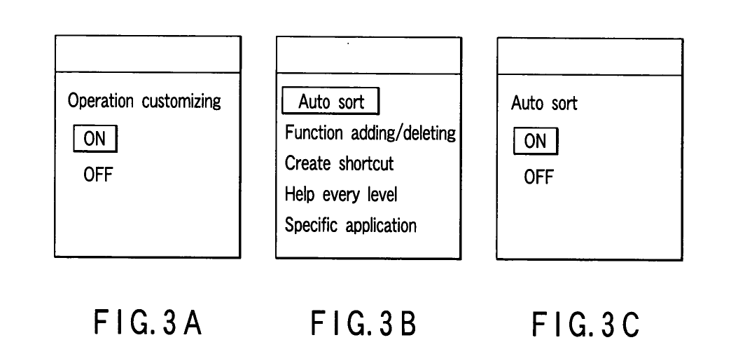

When instructions to execute the customizing setup procedure are given, the customizing setup unit 12b of the control unit 12 displays a customizing setup screen (step Al). FIG. 3A shows one example of the customizing setup screen. On the customizing setup screen, the user can select either of item ON for executing customizing or item OFF for executing no customizing. In a default state, the item ON is selected to execute the foregoing customizing.

If the item OFF is selected using a cursor key of the input device 14 (step A2, No), the customizing setup unit 12b ends the customizing setup procedure.

If the item ON is selected (step A2, Yes), the customizing setup unit 12b displays a customizing target select screen on the display 15 (step A3). FIG. 3B shows one example of the customizing target select screen. On the customizing target select screen, the following various items (customizing items) are prepared as a customizing target. For example, “auto sort”, “function adding/deleting”, “create shortcut”, “help every level” and “specific application” are given.

The “auto sort” is an item for customizing to automatically sort and store sent and received e-mails. If the “auto sort” customizing is set, the following settings are made. Specifically, when the user sends or receives e-mails, a storage location (folder) for sorting and saving these e-mails is automatically created in the receiving box 13a1 or sending box 13a2. Each e-mail is automatically sorted and stored in the corresponding storage location.

The “function adding/deleting” is an item for customizing to automatically adding/deleting items and icons in menus. If the “function adding/deleting” customizing is set, selection for instructing to execute various processings, for example, items and icons in menus is automatically added and deleted in accordance with an execution status relevant to e-mail processing.

The “create shortcut” is an item for customizing automatically create a shortcut for directly executing specific processing. If the “create shortcut” customizing is set, a shortcut for automatically and directly executing specific processing is automatically created if the frequency of using the specific processing relevant to e-mail is high (more than predetermined count).

The “help every level” is a item for customizing to change and display a help display content in accordance with an execution status (e.g., available frequency and time) of e-mail processing. If the “help every level” customizing is set, the help display content is changed in accordance with the execution status of e-mail processing, that is, the user's e-mail handling skill (level).

The “specific application” is an item for customizing to execute prepared specific processing (application) in accordance with the execution status of the mobile phone. If the “specific application” customizing is set, an image (animation) or speech expressing celebration is output when a count of executing specific processing exceeds a preset value.

If any item is selected using the input device 14 (step A4, Yes), the customizing setup unit 12b displays an on/off setup screen relevant to the selected customizing item on the display 15 (step A5).

For example, if “auto sort” is selected on the customizing target setup screen, the user can select either of item ON for executing the “auto sort” customizing or item OFF for executing no customizing, as seen from FIG. 3C.

If either of the foregoing item ON or OFF is selected, the customizing setup unit 12b stores the customizing setup data 13b in the storage unit 13 in response to the selection (step A7).

If an end of the customizing setup procedure is not given (step A8, No), the customizing setup unit 12b sets whether or not customizing relevant to a selected item on the customizing target select screen is executed in accordance with instructions from the user. In other words, the user can arbitrarily set auto customizing target processing.

Auto customizing relevant to arbitrary processing is set, and thereafter, when an end of the customizing setup procedure is given (step A8, Yes), the customizing setup unit 12b ends the customizing setup procedure.

The foregoing customizing setup procedure is arbitrarily executable so long as the user is accustomed to the operation of the mobile phone. However, there is a possibility that the user unaccustomed to the operation can not execute the customizing setup procedure. Therefore, the following setting is made in the mobile phone of the embodiment. Specifically, auto customizing is basically set to ON with respect to all processings in a default state.

In this case, even if the user makes a specific operation, auto customizing is executed in accordance with an execution status of e-mail processing.

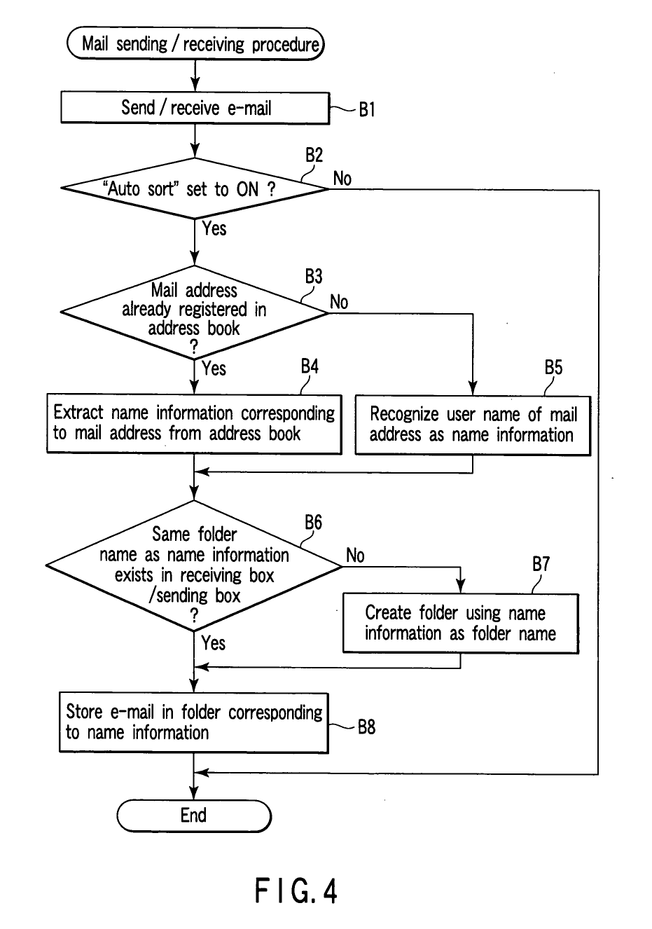

A mail sending/receiving procedure of this embodiment will be explained below with reference to a flowchart shown in FIG. 4.

When sending or receiving an e-mail (step B1), the mail processing unit 12a refers to the customizing setup data 13b to determine whether or not “auto sort” is set to ON.

If the “auto sort” is not set to ON (step B2, No), the mail processing unit 12a stores mail data of the sent or received e-mail in the storage unit 13. In this case, a sent mail is stored in the sending box 13a2 without sorting it into a specific folder. Likewise, a received mail is stored in the receiving box 13a1 without sorting it into a specific folder.

On the other hand, if the “auto sort” is set to ON (step B2, Yes), the mail sorting unit 12c determines whether or not the mail address of the sent or received e-mail is registered in an address book.

If the mail address is not registered in the address book (step B3, No), the mail sorting unit 12c recognizes a user name included in the mail address as name information used as a folder name of e-mail storage location, that is, folder (step B5).

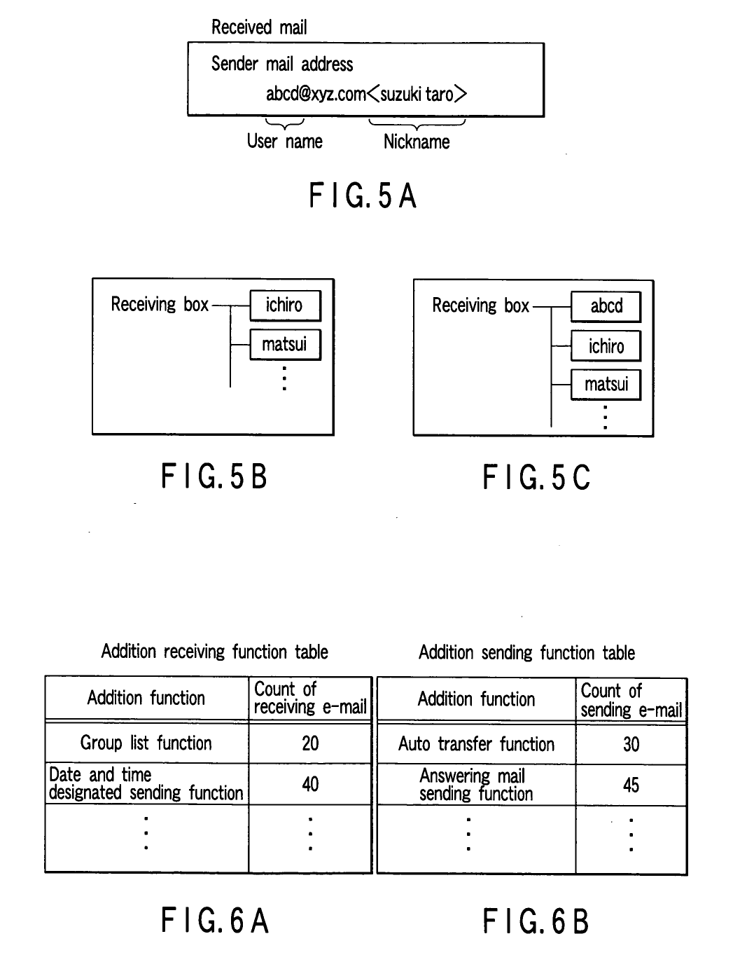

FIG. 5A shows one example of a sender mail address of a received e-mail. As shown in FIG. 5A, the mail address includes user name (equivalent to “abcd”), and domain name (equivalent to “xyz.com”). Incidentally, the mail address is attached with a nickname. The nickname is attached as user name previously registered wit respect to a communication terminal by mail program in the e-mail sender communication terminal.

If the mail address is registered in the address book (step B3, Yes), the mail sorting unit 12c extracts name information corresponding to the mail address from the address book (step B4).

Then, the mail sorting unit 12c determines whether or not the same folder as the name information exists in receiving box 13a1/sending box 13a2.

If a folder attached with the same folder name as the name information (step B6, Yes), the mail processing unit 12a stores the received or sent e-mail in the corresponding folder (step B8).

On the other hand, if there exists no folder attached with the same folder name as the name information (step B6, No), the mail sorting unit 12c creates a folder using name information as the folder name in the receiving box 13a1 or sending box 13a2 (step B7). Specifically, the mail sorting unit 12c newly creates a folder in the sending box 13a2 when sending e-mail; on the other hand, the mail sorting unit 12c newly creates a folder in the receiving box 13a1 when receiving e-mail.

When the same folder as the name information is newly created, the mail processing unit 12a stores the e-mail in the folder (step B8).

FIG. 5B shows one example of a folder created in the receiving box 13a1. The receiving box 13a1 shown in FIG. 5B is provided with several folders attached with folder names “ichiro”, “matsui”. If an e-mail having the sender mail address shown in FIG. 5A is received, a folder using user name “abcd” of the sender mail address as a folder name is created as seen from FIG. 5C. The received e-mail is stored in the newly created folder.

As described above, the “auto sort” customizing is set, and thereby, the following advantages are given. Specifically, the user has no need to manually create folders corresponding to e-mail sending destination and sender in receiving box 13a1 or sending box 13a2. Moreover, sent and received e-mails are sorted, and thereafter, stored. Therefore, the user has no need to select folders created in receiving box 13a1 or sending box 13a2 as a storage location. In other words, the sent and received e-mails are sorted and stored even if the user is unaccustomed to the operation of the mobile phone.

According to the foregoing mail sending/receiving procedure, when an e-mail is sent and received, the folder corresponding to the mail address of the e-mail is automatically created if “auto sort” is set to ON. In this case, a folder may be automatically created when a count of e-mail sending/receiving of the same mail address becomes more than a predetermined value.

For example, when sending/receiving an e-mail, the mail processing unit 12a registers total sending count/total receiving count every mail address of the e-mail as function execution status data 13e. If the foregoing total sending count/total receiving count exceeds a predetermined value (e.g., two times), a folder is automatically created and sorted. By doing so, only e-mail having many sending or receiving count is sorted.

The following is an explanation about the case where “function adding/deleting” customizing is set according to the customizing setup procedure. Herein, the procedure of adding selection to a menu to execute various processings with respect to e-mail is taken in accordance with an e-mail processing execution status by the mail processing unit 12a. In this case, a count of sending and receiving e-mail is used as a target of the execution status by the mail processing unit 12a.

A count of e-mail sending/receiving by the mail processing unit 12a reaches a preset count of addition receiving/sending function table 13d (addition receiving function table/addition sending function table. In this case, the function adding unit 12d adds a selection (function) corresponding to the count to menus.

FIG. 6A shows one example of data registered in the addition receiving function table, and FIG. 6B shows one example of data registered in the addition sending function table.

According to the addition receiving function table shown in FIG. 6A, “20” is preset to a “group list function” as a count of receiving e-mail, and “40” is preset to a “date and time designated sending function” as a count of receiving e-mail. For example, if the count of receiving e-mail reaches “20”, a selection (item, icon) for instructing to execute the “group list function” is added to the menu so that the user can use the function.

According to the addition sending function table shown in FIG. 6B, “30” is preset to an “auto transfer function” as a count of sending e-mail, and “45” is preset to a “answering mail sending function” as a count of sending e-mail. For example, if the count of sending e-mail reaches “30”, a selection (item, icon) for instructing to execute the “auto transfer function” is added to the menu so that the user can use the function.

As seen from FIG. 6A and FIG. 6B, the count preset to each adding function is not necessarily fixed. Moreover, in the foregoing addition receiving function table/addition sending function table, the count to each function may be set so that a readily operable function is successively added. In this case, the user is gradually accustomed to the operation of the mobile phone, and thereby, it is possible to provide a function requiring a complicated operation.

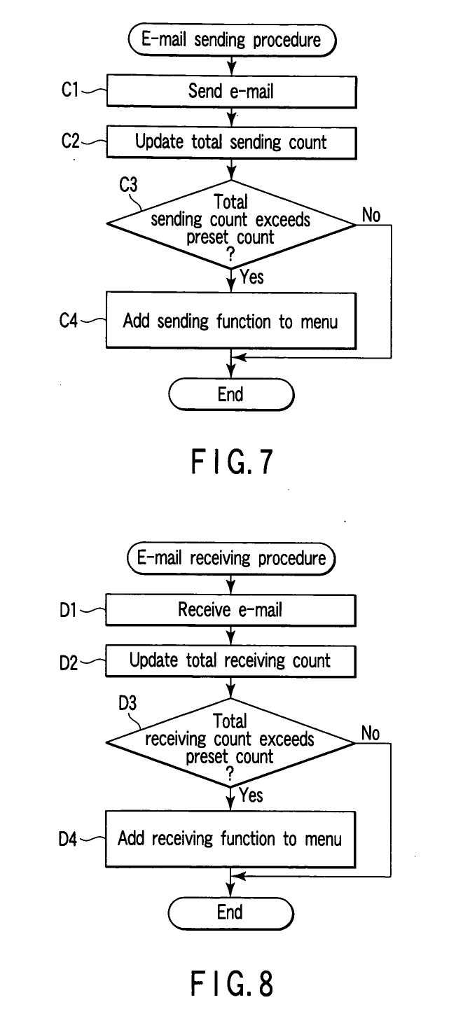

An e-mail sending procedure will be explained below with reference to a flowchart shown in FIG. 7.

First, the user creates an e-mail using the input device 14, and then, the e-mail is sent (step C1). Then, the mail processing unit 12a updates the total sending count stored in the storage unit 13 as a function execution status data 13e (step C2).

Here, the function adding unit 12d determines whether or not the total sending count reaches the sending count preset in the addition sending function table.

For example, the unit 12d determines whether or not the sending count reaches “30” according to the addition sending function table shown in FIG. 6B.

If the total sending count does not reach the preset count (step C3, No), the function adding unit 12d ends the procedure without adding a function (selection item) to the menu.

On the other hand, if the total sending count reaches the preset count (step C3, Yes), the function adding unit 12d takes the following procedure. Specifically, the unit 12d updates the menu management data 13c to add a selection item corresponding to the addition function corresponding to the reached sending count (step C4).

For example, if the sending count reaches “30”, the unit 12d adds a selection item corresponding to the “auto transfer function” to the menu so that the user can instruct to execute the function from the menu.

In the manner described above, the total sending count is updated every when an e-mail is sent. If the count reaches the sending count preset in the addition sending function table, the selection item is added to the menu so that the user can use the function corresponding to the count.

An e-mail receiving procedure will be explained below with reference to a flowchart shown in FIG. 8.

First, an e-mail is received via the user's operation of the input device 14 or notification from the outside receiving an e-mail (step D1). Then, the mail processing unit 12a updates the total receiving count stored in the storage unit 13 as a function execution status data 13e (step D2).

Here, the function adding unit 12d determines whether or not the total receiving count reaches the sending count preset in the addition receiving function table.

For example, the function adding unit 12d determines whether or not the receiving count reaches “20” according to the addition receiving function table shown in FIG. 6A.

If the total receiving count does not reach the preset count (step D3, No), the function adding unit 12d ends the procedure without adding a function (selection item) to the menu.

On the other hand, if the total receiving count reaches the preset count (step D3, Yes), the function adding unit 12d takes the following procedure. Specifically, the function adding unit 12d updates the menu management data 13c to add a selection item corresponding to the addition function corresponding to the reached receiving count (step D4).

For example, if the receiving count reaches “20”, the function adding unit 12d adds a selection item corresponding to the “group list function” to the menu so that the user can instruct to execute the function from the menu.

In the manner described above, the total receiving count is updated every when an e-mail is received. If the count reaches the receiving count preset in the addition receiving function table, the selection item is added to the menu so that the user can use the function corresponding to the count.

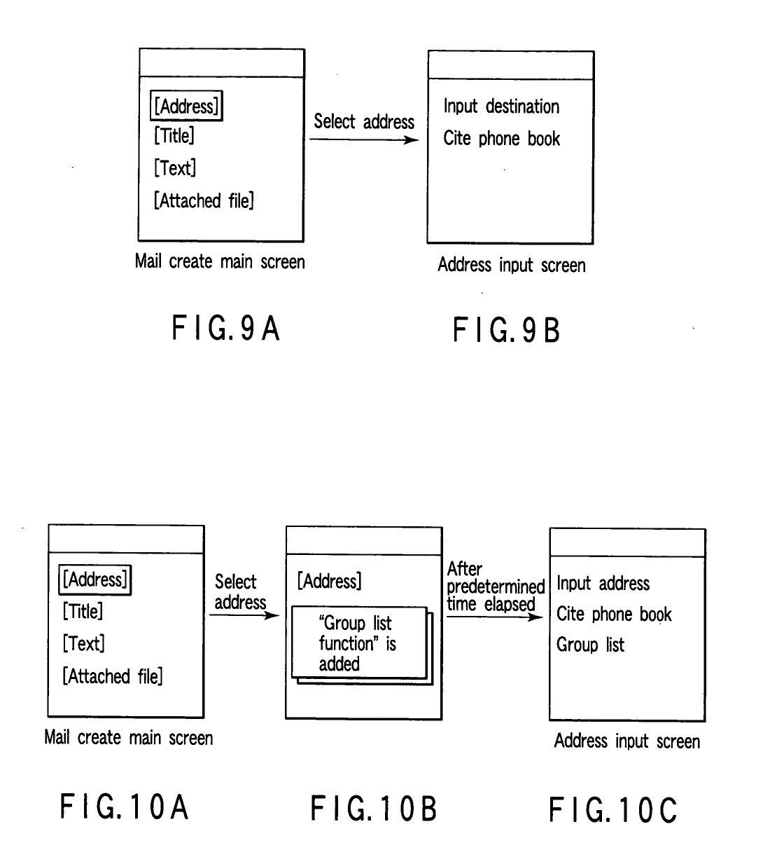

FIG. 9A, FIG. 9B and FIG. 10A, FIG. 10B and FIG. 10C each show an example of adding a function (selection item) to a menu. These FIG. 9A, FIG. 9B and FIG. 10A, FIG. 10B and FIG. 10C show a screen displayed on the display 15 when the user creates an e-mail.

When instructions to execute “create a new e-mail” are given, the mail processing unit 12a displays a mail create main screen shown in FIG. 9A. The mail create main screen is provided with items for instructing to input e-mail data, that is, “Address”, “Title”, “Text”, and “Attached file”.

If the item “Address” is selected, the mail processing unit 12a displays an address input screen shown in FIG. 9B. FIG. 9B shows an address input screen in the initial state that no any function is added to menu. In the initial state menu, items “Address input” and “Cite (Use) phone book” are set. The item “Address input” is a function of directly inputting an address using dial keys of the input device 14. The “Cite (Use) phone book” is a function of selecting registered data from an address book (phone book).

In the initial state that the user is unaccustomed to the operation of the mobile phone, readily operable function only is set as a menu as seen from FIG. 9B.

On the other hand, according to the foregoing e-mail sending procedure, the “group list function” is added to the menu as a selection item.

In this case, when an item “Address” is selected, the mail processing unit 12a displays a message for giving the following notice to the user. The message notifies that “group list function” is added as a function of inputting the “Address”, as depicted in FIG. 10B.

The foregoing message is displayed for predetermined time (e.g., one second), and thereafter, the mail processing unit 12a displays an address input screen shown in FIG. 10C. FIG. 10C shows an address input screen added with the item “group list function” in the menu. Therefore, when user inputs an e-mail address, the item “group list function” is usable in addition to items “Address input” and “Use phone book”.

A count of sending e-mail increases, and then, reaches the sending count preset in the addition sending function table. This implies that the user's skill relevant to the operation of the mobile phone is improved. Therefore, a selection item corresponding to a new function is added and set to the menu so that the new function is successively usable.

A function of receiving an e-mail is given in the same manner as the case of sending an e-mail. Specifically, when a count of receiving an e-mail gradually increases, a selection item for executing a new function is added to the menu.

The following is an explanation about the procedure of deleting a selection item from a menu for instructing to execute e-mail processing in accordance with an execution status of e-mail processing by the mail processing unit 12a.

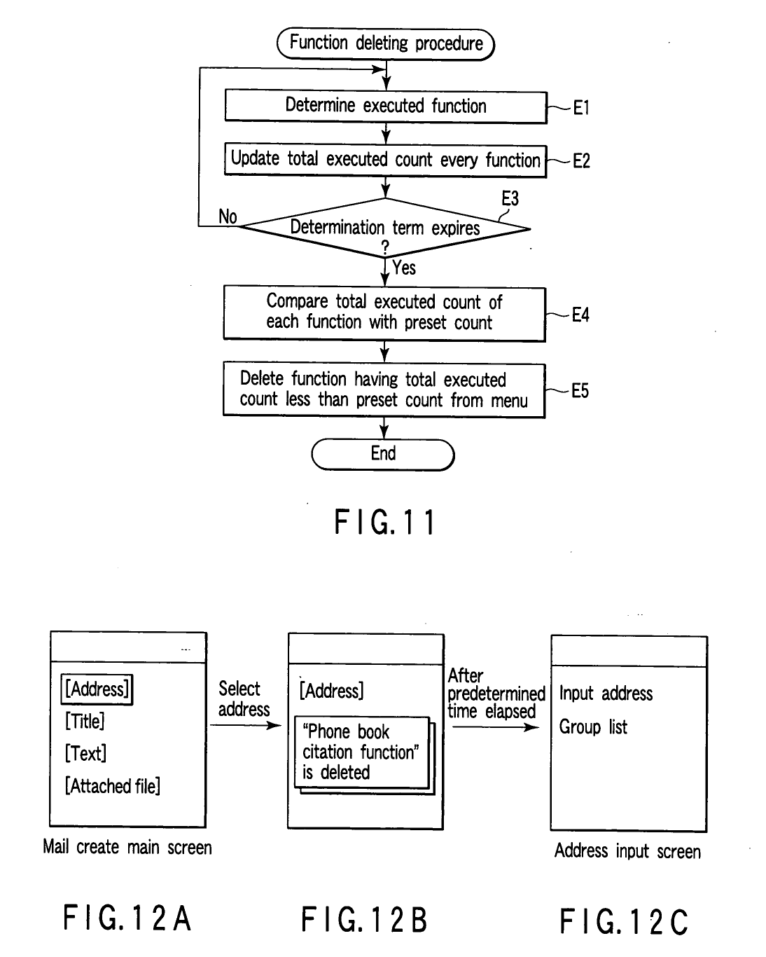

FIG. 11 shows a flowchart to explain a function deleting procedure in the embodiment.

The function deleting unit 12e determines a function (processing) executed with respect to e-mail (step E1). Then, the unit 12e updates a total count of executing the function (step E2). In other words, the unit function deleting 12e stores a total count every function as a function execution status data 13e every when various functions are executed.

As described above, the unit function deleting 12e stores the total count executed every function as a function execution status data 13e every when various functions are executed until a preset determination term expires (step E3, No). The determination term is a term for determining deletion of selection item from a menu; for example, a term such as week and month is preset. Moreover, the determination term may be set according to the user's designation.

If it is determined that the determination term expires (step E3, Yes), the function deleting unit 12e compares the total count executed every function stored as the function execution status data 13e with a preset count (step E4). In this case, the preset count is set to a count, which is determined that there is no problem even if the function is deleted because the user's available frequency is low. Moreover, the preset count may be set according to the user's designation.

If there exist a function having the total executed count less than the preset count, the function deleting unit 12e updates the menu management data 13c to delete the selection item corresponding to the function (step E5).

Thereafter, the function deleting unit 12e initializes the total count executed every function recorded as the function execution status data 13e. Then, the unit 12e determines a total executed count within a newly next determination term.

FIG. 12A to FIG. 12C show an example of deleting a function (selection item) from menu.

On a mail create main screen shown in FIG. 12A, when an item “Address” is selected, the mail processing unit 12a displays a message for giving the following notice to the user. The message notifies that “Phone book citation” set to menu as a function for inputting “Address” is deleted, as depicted in FIG. 12B.

The foregoing message is displayed for predetermined time (e.g., one second), and thereafter, the mail processing unit 12a displays an address input screen shown in FIG. 12C. FIG. 12C shows an address input screen added with the item “group list function” in the menu. By doing so, when the user inputs e-mail address, the “Use phone book” function having a low available frequency is deleted from the menu. In other words, only selection item having a high available frequency is set in the menu. Therefore, the user can readily select a function to be executed from the menu.

According to the customizing setup procedure, the “function adding/deleting” customizing is set, and thereby, the following advantages are given. Specifically, a count of executing e-mail processing of the mobile phone gradually increases, and thereby, selection item is added to the menu so that a new function is executed even if user makes no any operation. On the other hand, of functions set in the menu, the selection item corresponding to the function having a low available frequency is deleted from the menu even if the user makes no operation. Therefore, functions are set in the menu in accordance with the user's execution status relevant to e-mail processing. As a result, a menu is customized having operability favorable to the user.

In the foregoing embodiment, the explanation abut customizing relevant to “auto sort” and “function adding/deleting” according to the customizing setup procedure has been made. Other functions “create shortcut”, “help every level” and “specific application” are customized in accordance with the execution status of e-mail processing.

For example, if the function “create shortcut” is set as a customizing target, a total executed count is recorded with respect to each e-mail processing. If the total executed count of one processing exceeds a preset count, the menu management data 13c is updated to display a shortcut for starting the processing on a predetermined screen. Processing having a high available frequency is simply started by selecting a shortcut preset on a predetermined screen.

If the function “help every level” is set as a customizing target, a total executed count is recorded with respect to each e-mail processing. Then, it is determined that the total executed count corresponds to any one of several levels (e.g. higher, medium, beginner). In other words, the user's skill (level) relevant to e-mail processing is determined based on the total executed count. If the user requests a help display relevant to a certain function (processing), help information reflecting the content corresponding to a level determined based on the total executed count is displayed. By doing so, information reflecting the content suitable to the user's skill level is provided without the user's specific operation.

If the function “specific application” is set as a customizing target, a total executed count is recorded with respect to each e-mail processing. If the total executed count reaches a preset count, prepared specific processing (application) is executed. For example, if a count of sending e-mail exceeds a predetermined value, animation and speech expressing celebration are output. For example, several applications are prepared for each function. By doing so, when a count of executing each function exceeds a preset value, the corresponding application is executable without the user's specific operation.

In the foregoing embodiment, a count of sending/receiving e-mail is used as a target for execution status. In this case, available frequency or time relevant to e-mail processing is updated as the function execution status data 13e, and based on the data, customizing may be executed.

What is claimed is:

1. A communication terminal comprising:
a mail processing unit configured to execute e-mail processing;
a status determining unit configured to determine an execution status of the e-mail processing; and
a customizing executing unit configured to execute customizing with respect to the e-mail processing in accordance with the execution status determined by the status determining unit.

2. The communication terminal according to claim 1, wherein the status determining unit determines a count of receiving e-mail and sending e-mail as the execution status of the e-mail processing.

3. The communication terminal according to claim 1, wherein the customizing executing unit includes:
a storage location determining unit configured to determine whether or not a storage location corresponding to a mail address of an e-mail is set if sending the e-mail and receiving the e-mail;
a storage location setup unit setting a storage location corresponding to the mail address if the storage location determining unit determines that the storage location is not set; and
an e-mail storage unit storing data of the sent e-mail and received e-mail in the storage location set by the storage location determining unit.

4. The communication terminal according to claim 1, wherein the customizing executing unit is configured to add a selection item to a menu for instructing to execute various e-mail processing in accordance with the execution status determined by the status determining unit.

5. The communication terminal according to claim 1, wherein the customizing executing unit is configured to delete a selection item from a menu for instructing to execute various e-mail processing in accordance with the execution status determined by the status determining unit.

6. The communication terminal according to claim 4, further comprising:
an execution status storage unit configured to store an execution status adding the selection item by the customizing executing unit every selection item added to the menu, and wherein
the customizing executing unit is configured to add a selection item corresponding to the execution status to the menu if the status determining unit determines that the execution status stored in the execution status storage unit is given.

7. The communication terminal according to claim 4, wherein the customizing executing unit is configured to delete a selection item from a menu for instructing to execute various e-mail processing in accordance with the execution status determined by the status determining unit.

8. The communication terminal according to claim 4, further comprising:
a customizing setup unit configured to set whether or not customizing by the customizing executing unit is executed, and wherein
the customizing executing unit is configured to execute customizing if execution of customizing is set by the customizing setup unit.

9. The communication terminal according to claim 8, wherein the customizing setup unit is configured to set whether or not customizing is executed with respect to each of several e-mail processings.

10. The communication terminal according to claim 1, wherein
the status determining unit is configured to record a count of executing processing as a status of the e-mail processing, and
the customizing executing unit is configured to determine whether the count of executing processing recorded by the status determining unit corresponds to any one of several levels.

11. The communication terminal according to claim 1, wherein
the status determining unit is configured to record a count of executing processing as a status of the e-mail processing, and
the customizing executing unit is configured to execute prepared processing if the count of executing processing recorded by the status determining unit reaches a preset count.

12. A communication terminal having a function of sending and receiving an e-mail, comprising:
a count storage unit configured to store a first count of sending an e-mail and a second count of receiving an e-mail;
a first preset count storage unit configured to store a first count set with respect to a first function relevant to e-mail sending;
a second preset count storage unit configured to store a second count set with respect to a second function relevant to e-mail receiving;
a first adding unit configured to add a first selection item for instructing to execute the first function to a first menu for executing a function relevant to e-mail sending if the first count of sending an e-mail stored by the count storage unit exceeds the first count; and
a second adding unit configured to add a second selection item for instructing to execute the second function to a second menu for executing a function relevant to e-mail receiving if the second count of receiving an e-mail stored by the count storage unit exceeds the second count.

13. The communication terminal according to claim 12, wherein
the first preset count storage unit is configured to be stored with the first count preset with respect to each of several first functions,
the first adding unit is configured to add a selection item of the first function corresponding to a stored count to the first menu if the count of sending exceeds the first count,
the second preset count storage unit is configured t be stored with the second count preset with respect to each of several second functions, and
the second adding unit is configured to add a selection item of the second function corresponding to a stored count to the second menu if the count of sending exceeds the second.

14. The communication terminal according to claim 12, further comprising:
a first execution count update unit configured to update a first execution count every if the first function is executed;
a second execution count update unit configured to update a second execution count every if the second function is executed;
a first deleting unit configured to delete a selection item corresponding to the first function from the first menu if the first execution count in a preset determination term is less than a preset first count; and
a second deleting unit configured to delete a selection item corresponding to the second function from the second menu if the second execution count in a preset determination term is less than a preset second count.
